(19) United States
(12) Patent Application Publication
(10) Pub. No.: US 2020/0032659 A1
(43) Pub. Date: Jan. 30, 2020

(54) SNUBBERED BLADES WITH IMPROVED FLUTTER RESISTANCE

(71) Applicant: Siemens Aktiengesellschaft, München (DE)

(72) Inventors: Yuekun Zhou, Charlotte, NC (US); Ching-Pang Lee, Cincinnati, OH (US)

(21) Appl. No.: 16/491,259

(22) PCT Filed: Feb. 26, 2018
(86) PCT No.: PCT/US2018/019707

§ 371 Date: Sep. 5, 2019

Related U.S. Application Data
(60) Provisional application No. 62/470,446, filed on Mar. 13, 2017.

(51) Int. Cl. F01D 5/24

(52) U.S. Cl. CPC F01D 5/24; F05D 2260/961; F05D 2240/301

(57) ABSTRACT

A bladed rotor system (10) for a turbomachine includes a row of blades (14) mounted on a rotor disc (12). Each blade (14) includes an airfoil (16) with a mid-span snubber (30). The row of blades (14) includes first (H) and second (L) sets of blades (14). The blades (14) of the second set (L) are distinguished from the blades (14) of the first set (H) by a geometry of the snubber (30) that is unique to the respective set (H, L). In particular, the snubbers (30) of the second set (L) are attached to the respective airfoils (16) at a different span-wise height than that of the snubbers (30) of the first set (H). Thereby the natural frequency of a blade (14) in the second set (L) differs from the natural frequency of a blade (14) in the first set (H) by a predetermined amount. Blades (14) of the first set (H) and the second set (L) are positioned alternately in the row of blades (14), to provide a frequency mistuning to stabilize flutter of the blades (14).

### BACKGROUND

### 1. Field

The present invention is relates to rotating blades in a turbomachine, and in particular, to a row of snubbered blades with alternate frequency mistuning for improved flutter resistance.

### 2. Description of the Related Art

Turbomachines, such as gas turbine engines include multiple stages of flow directing elements along a hot gas path in a turbine section of the gas turbine engine. Each turbine stage comprises a circumferential row of stationary vanes and a circumferential row of rotating blades arranged along an axial direction of the turbine section. Each row of blades may be mounted on a respective rotor disc, with the blades extending radially outward from the rotor disc into the hot gas path. A blade includes an airfoil extending span-wise along the radial direction from a root portion to a tip of the airfoil.

Typical turbine blades at each stage are designed to be identical aerodynamically and mechanically. These identical blades are assembled together into the rotor disc to form a bladed rotor system. During engine operation, the bladed rotor system vibrates in system modes. This vibration may be more severe in large blades, such as in low pressure turbine stages. An important source of damping in the modes is from aerodynamic forces acting on the blades when the blades vibrate. Under certain conditions, the aerodynamic damping in some of the modes may become negative, which may cause the blades to flutter. When this happens, the vibratory response of the system tends to grow exponentially until the blades either reach a limit cycle or break. Even if the blades achieve a limit cycle, their amplitudes can still be large enough to cause the blades to fail from high cycle fatigue.

In order to increase the blade natural frequency and decrease the tendency of the blades to flutter, blades may be provided with tip-shrouds or snubbers. The difference between a snubber and a tip-shroud is that a tip-shroud is disposed over the tip of the airfoil, while a snubber is generally disposed away from the tip, typically attached at a mid-span of the airfoil. FIG. 1 illustrates turbine blades with tip-shrouds 90, while FIG. 2-3 illustrate turbine blades with mid-span shrouds or snubbers 30. Both tip-shrouds and snubbers work on the same principle: An airfoil is typically installed on the rotor disk with a pre-twist. During engine operation, the airfoil tends to untwist due to centrifugal forces. The tip-shroud or snubber, which is attached to the airfoil, comes into contact with adjacent tip-shrouds or snubbers, due to the rotation of the blades, to form a ring when the blades reach a certain rotational speed. The ring provides a constraint that causes the frequencies of the blades to increase, which decreases the tendency of the blades to flutter.

However, there remains a room for improvement to better address the problem of blade vibration.

### SUMMARY

Briefly, aspects of the present invention are directed to snubbered blades with alternate frequency mistuning for improved flutter resistance.

According a first aspect of the present invention, a bladed rotor system for a turbomachine is provided. The bladed rotor system comprises a circumferential row of blades mounted on a rotor disc. Each blade comprises an airfoil extending span-wise along a radial direction from a root portion to an airfoil tip, and a circumferentially extending snubber attached to the airfoil at a mid-span region of the airfoil. In operation, snubbers of adjacent blades abut circumferentially. The row of blades comprises a first set of blades and a second set of blades. The blades of the second set are distinguished from the blades of the first set by a geometry of the snubber that is unique to the respective set, in which: the snubbers of the second set are attached to the respective airfoils at a different span-wise height than that of the snubbers of the first set. Thereby the natural frequency of a blade in the second set differs from the natural frequency of a blade in the first set by a predetermined amount. Blades of the first set and the second set are positioned alternately in the row of blades, to provide a frequency mistuning to stabilize flutter of the blades.

According a second aspect of the present invention, a blade is provided for a row of blades in a turbomachine. The blade comprises an airfoil extending span-wise along a radial direction from a root portion to an airfoil tip, and a circumferentially extending snubber attached to the airfoil at a mid-span region of the airfoil. The blade is designed to be identical to a first set of blades or a second set of blades in the row. The blades of the second set are distinguished from the blades of the first set by a geometry of the snubber that is unique to the respective set, in which: the snubbers of the second set are attached to the respective airfoils at a different span-wise height than that of the snubbers of the first set. Thereby, the natural frequency of a blade in the second set differs from the natural frequency of a blade in the first set by a predetermined amount. Blades of the first set and the second set are positioned alternately in the row of blades, to provide a frequency mistuning to stabilize flutter of the blades.

### BRIEF DESCRIPTION OF THE DRAWINGS

The invention is shown in more detail by help of figures. The figures show preferred configurations and do not limit the scope of the invention.

FIG. 1 illustrates a row of rotating blades with tip-shrouds;

FIG. 2 illustrates a row of rotating blades with snubbers;

FIG. 3 is a perspective view of an individual blade with a snubber attached to mid-span of the blade airfoil;

FIG. 4 is a schematic illustration of an axial end view of a bladed rotor system having alternately mistuned snubbers in accordance with an example embodiment of the invention;

FIG. 5 is a schematic illustration of an axial end view of a bladed rotor system having alternately mistuned snubbers in accordance with another example embodiment of the invention; and

FIG. 6 graphically illustrates alternate mistuning in a row of turbine blades.

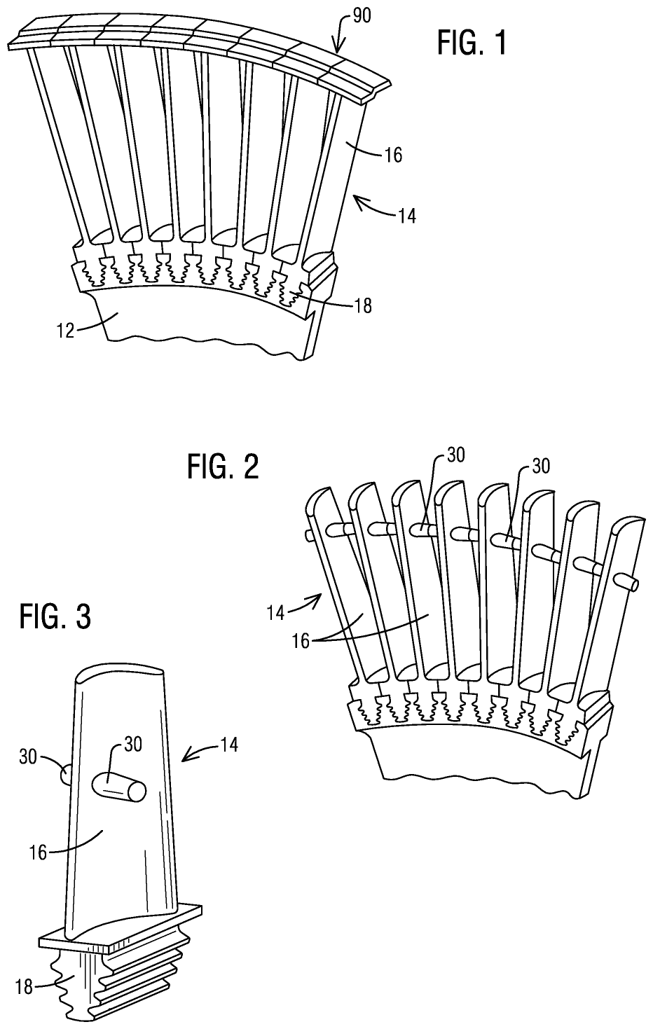

### DETAILED DESCRIPTION

In the following detailed description of the preferred embodiments, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

In the drawings, the direction A denotes an axial direction parallel to an axis of the turbine engine, while the directions R and C respectively denote a radial direction and a circumferential direction with respect to said axis of the turbine engine.

Illustrated embodiments of the present invention are directed to snubbered turbine blades in a turbine section of a gas turbine engine. However, the embodiments herein are merely exemplary. Alternately, for example and without limitation, aspects of the present invention may be incorporated in fan blades at the entry of a compressor section of an aviation gas turbine engine.

It has been found that alternate frequency mistuning can cause system modes to be distorted, so that the resulting new, mistuned system modes are stable, i.e., they all have positive aerodynamic damping. It is therefore desirable to be able to design blades with a certain amount of predetermined alternate mistuning. Alternate mistuning may be implemented in blades by having the blades in the blade row alternate between high and low frequencies in periodic fashion in the circumferential direction. So far, alternate mistuning of blades has been implemented by modifying the mass and/or geometry of the airfoil in alternate blades in a blade row.

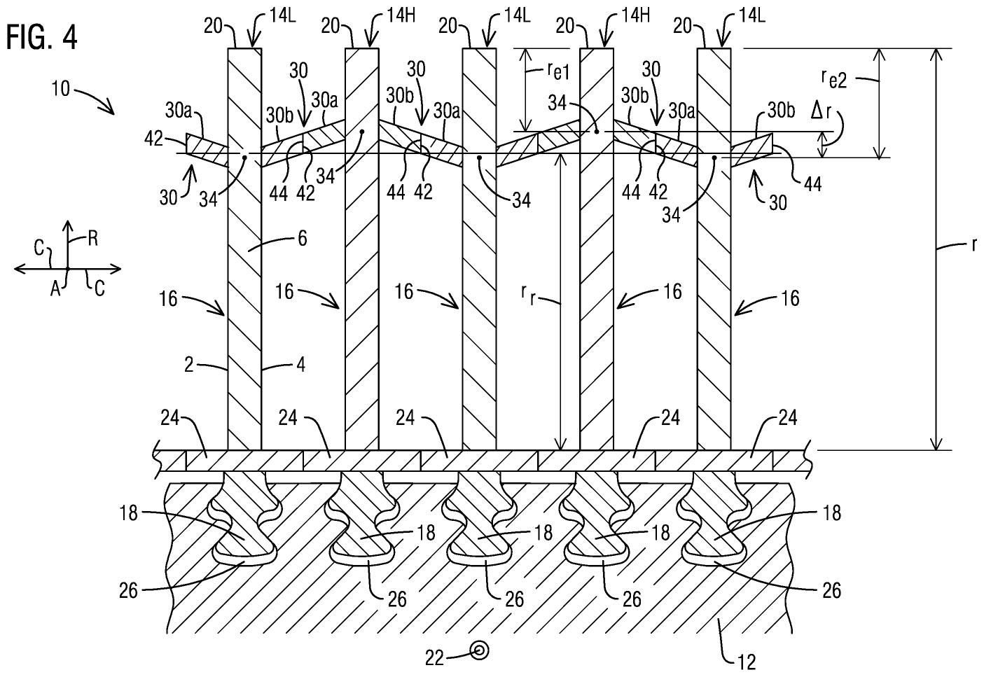

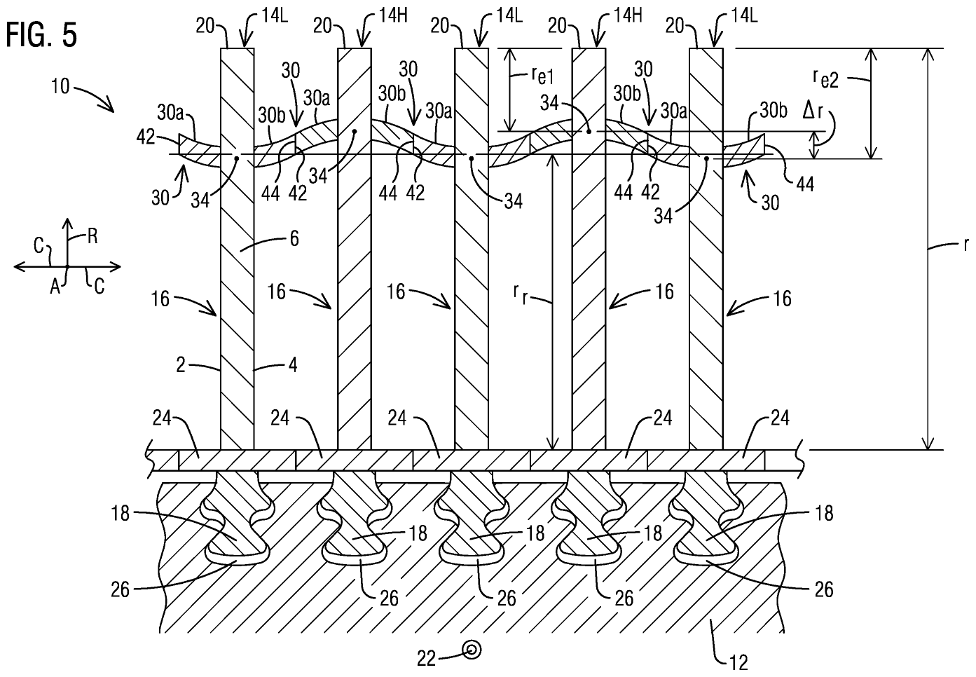

Embodiments of the present invention are based on the principle of modifying a geometry of the snubber for a set of blades in the blade row, so that said set of blades are mistuned, having a different frequency in relation to the rest of the blades in the blade row. Modifying the snubber geometry may involve modifying the radial (span-wise) location of snubbers. In accordance with the illustrated embodiments depicted in FIG. 4-5, a circumferential row of blades 14 mounted on a rotor disc 12 may comprises a first set H of blades 14 and a second set L of blades 14. The airfoils 16 in the first set H and the second L set of blades 14 may have essentially identical cross-sectional geometry about the rotation axis 22. That is, the airfoil cross-sectional shape as well as the angle of the airfoil chord with the rotation axis 22 may be substantially constant across the first set H and the second set L of blades 14. Further, in the context of the illustrated embodiments, it may be assumed that each blade 14 of the blade row has essentially identical fir-tree attachments (blade root) for mounting the blade 14 on the rotor disc 12. The blades 14 of the second set L are distinguished from the blades 14 of the first set H by a geometry of the snubber 30 that is unique to the respective set H or L. In particular, the snubbers 30 of the second set L are attached to the respective airfoils 16 at a different span-wise or radial height than that of the snubbers 30 of the first set H, which may change the free length of the airfoils 16 from the point of snubber attachment 34 to the airfoil tip 20. Thereby the natural frequency of a blade 14 in the second set L differs from the natural frequency of a blade 14 in the first set H by a predetermined amount. In the illustrated examples, the blades 14 in the second set L are mistuned, having a lower frequency than the blades 14 of the first set H. The blades 14 of the first set H and the second set L may be alternately arranged in the blade row, to provide frequency mistuning to stabilize flutter of the blades 14.

In the context of the specification, a snubber is understood to be a shroud which is attached at a mid-span region of a blade airfoil. A mid-span region may be understood to be any region located between the root and the tip of the airfoil. In exemplary embodiments, mid-span snubbers may be located between 40-70% of the span of the airfoil as measured from the root.

Referring now to FIG. 4, a portion of bladed rotor system 10 is illustrated in accordance with one embodiment of the present invention. The bladed rotor system 10 includes a circumferential row of blades 14 mounted on a rotor disc 12. Each blade 14 comprises an airfoil 16 extending span-wise along a radial direction from a root portion 18 to an airfoil tip 20. As known to one skilled in the art, the airfoil 16 may comprise a generally concave pressure side 2 and a generally convex suction side 4, joined at a leading edge 6 and at a trailing edge (not shown). A radially inner end of the airfoil 16 is coupled to a root 18 at a platform 24. In the illustrated embodiment, the root 18 has a fir-tree shape, which fits into a correspondingly shaped slot 26 in a rotor disk 12. In order to increase the blade natural frequency and decrease the tendency to flutter, the blade 14 may be provided with a circumferentially extending snubber 30 attached to the airfoil 16 at a mid-span region of the airfoil 16. The platforms 24 of adjacent blades 14 in the blade row abut each other to form an inner flowpath boundary for a hot gas, and the airfoils 16 extend radially outward across the flowpath.

Each snubber 30 comprises a pressure side snubber portion 30a extending from the pressure side 2 of the respective airfoil 16 to a pressure side snubber edge 42, and a suction side snubber portion 30b extending from the suction side 4 of the respective airfoil 16 to a suction side snubber edge 44. Each blade airfoil 16 may be twisted about its span-wise axis. During engine operation, the blades 14 rotate about a rotation axis 22, whereby centrifugal and aerodynamic forces untwist each blade airfoil 16 in the blade row so that the pressure side snubber edge 42 of each snubber 30 abuts the suction side snubber edge 44 of a neighboring snubber 30, to form a ring. The abutting contact between neighboring snubbers 30 helps to limit the untwisting of the blade and establish the blade's precise orientation during operation. The snubber ring provides a constraint that causes the frequencies of the blades to increase, which decreases the tendency of the blades to flutter.

In accordance with the illustrated embodiment, a geometry of the snubber 30 may be modified for a set L of blades in the blade row, so that said set of blades L are mistuned in relation to the remaining blades H in the blade row. In this embodiment, this is achieved by moving the location of the point of attachment 34 of the airfoil 16 and snubber 30 to a radially lower height for blades 14 in the second set L, in relation to that of the blades 14 in the first set H. As shown, each blade 14 of the first set H is adjacent, on either side, to a neighboring blade 14 of the second set L. The shift in position of the point of attachment 34 between the adjacent blades 14 is depicted as Δr. As a result, a free length rₑ₂ of the airfoils 16 in the second set L is larger than a free length rₑ₁ of the airfoils 16 in the first set H. The free length of an airfoil 16 being may be defined as a radial distance between the airfoil tip 20 and a point of attachment 34 of the airfoil 16 with the associated snubber 30. Because of the difference in free lengths of the adjacent airfoils 16, the blades 14 in the second row L have a slightly lower frequency than the blades 14 in the first set H. The total radial height r from the root to the airfoil tip is typically constant for each airfoil 16 across the first and second sets of blades.

In a preferred embodiment, snubbers 30 of adjacent blades 14 of the row of blades meet at a constant radial height rᵣ. This may be achieved by designing adjacent snubbers 30 with alternate orientations in relation to the radial direction. In the illustrated embodiment, the pressure side snubber portion 30a and the suction side snubber portion 30b of the snubbers 30 in the second set L are oriented differently than the pressure side snubber portion 30a and the suction side snubber portion 30b of the snubbers 30 in the first set H. In particular, the pressure side snubber portion 30a and the suction side snubber portion 30b of each snubber 30 in the first set H extends radially inwardly from the point of attachment 34 toward the respective snubber edges 42, 44. Correspondingly, the pressure side snubber portion 30a and the suction side snubber portion 30b of each snubber 30 in the second set L extends radially outwardly from the point of attachment 34 toward the respective snubber edges 42, 44.

In the embodiment illustrated in FIG. 4, the pressure side and suction side snubber portions 30a, 30b are oriented straight, pointing radially inward or outward. That is, the pressure side snubber portion 30a and the suction side snubber portion 30b of each snubber 30 in the first set H extends radially inwardly from the point of attachment 34 along a linear profile. Correspondingly, the pressure side snubber portion 30a and the suction side snubber portion 30b of each snubber 30 in the second set L extends radially outwardly from the point of attachment 34 along a linear profile. However, the above configuration is exemplary and other snubber geometries may be considered. For example, in an alternate embodiment shown in FIG. 5, the snubbers 30 may have a curved profile extending radially outward or radially inward. As shown in this example, the pressure side snubber portion 30a and the suction side snubber portion 30b of each snubber 30 in the first set H is curved radially inward from the point of attachment 34. Correspondingly, the pressure side snubber portion 30a and the suction side snubber portion 30b of each snubber 30 in the second set L is curved radially outward from the point of attachment 34. In each of the illustrated embodiments, the snubbers 30 in the first set H and the second set L may have the same mean radial thickness.

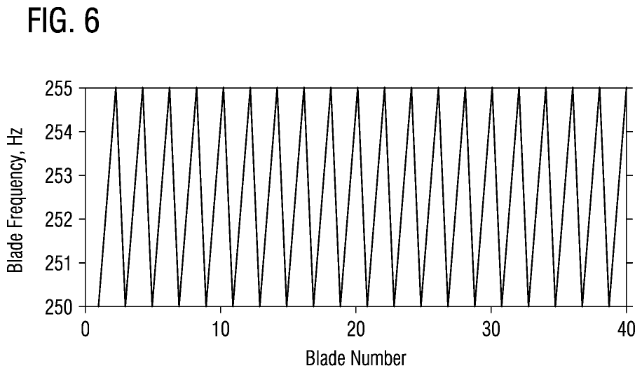

As an example, to effectively stabilize flutter, the snubber geometries may be modified to achieve a mistuning of about 1.5-2% above manufacturing tolerances. FIG. 6 graphically illustrates alternate mistuning in a row of 40 turbine blades. Herein, the odd number blades have a frequency of 250 Hz, while the even numbered blades have a frequency of 255 Hz. In this example, the difference in blade frequencies is 5 Hz. Consequently, the frequency of even numbered blades is 2% than the frequency of odd numbered blades, i.e., the amount of mistuning is 2%.

As illustrated above, the cross-sectional geometry of the airfoils about the rotation axis are essentially the same for both the high-frequency blades H and the low frequency blades L. This makes it easier to design the airfoil to have optimum aerodynamic efficiency since a uniform airfoil geometry has to be considered. Moreover, the illustrated embodiments make it possible to employ alternate mistuning for blades with hollow airfoils, for example, containing internal cooling channels. The design of hollow airfoils is more constrained than the design of solid airfoils. The use of mistuned snubbers provide a possibility for implementing alternate mistuning for such hollow blades without compromising the aero-efficiency.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A bladed rotor system (10) for a turbomachine, comprising:
a circumferential row of blades (14) mounted on a rotor disc (12), each blade (14) comprising:
an airfoil (16) extending span-wise along a radial direction from a root portion (18) to an airfoil tip (20); and
a circumferentially extending snubber (30) attached to the airfoil (16) at a mid-span region of the airfoil (16),
wherein in operation, snubbers (30) of adjacent blades (14) abut circumferentially,
wherein the row of blades (14) comprises a first set (H) of blades (14) and a second set (L) of blades (14), wherein the blades (14) of the second set (L) are distinguished from the blades (14) of the first set (H) by a geometry of the snubber (30) that is unique to the respective set (H, L), in which:
the snubbers (30) of the second set (L) are attached to the respective airfoils (16) at a different span-wise height than that of the snubbers (30) of the first set (H), whereby the natural frequency of a blade (14) in the second set (L) differs from the natural frequency of a blade (14) in the first set (H) by a predetermined amount,
wherein blades (14) of the first set (H) and the second set (L) are positioned alternately in the row of blades (14), to provide a frequency mistuning to stabilize flutter of the blades (14).

2. The bladed rotor system (10) according to claim 1, wherein the airfoils (16) in the first (H) and second (L) set having substantially identical cross-sectional geometry about a rotation axis (22).

3. The bladed rotor system (10) according to claim 1, wherein a free length (rₑ₂) of the airfoils (16) in the second set (L) is larger than a free length (rₑ₁) of the airfoils (16) in the first set (H),
the free length (rₑ₁, rₑ₂) of an airfoil (16) being defined as a radial distance between the airfoil tip (20) and a point of attachment (34) of the airfoil (16) with the associated snubber (30).

4. The bladed rotor system (10) according to claim 3, wherein each snubber (30) comprises a pressure side snubber portion (30a) extending from a pressure side (2) of the respective airfoil (16) and a suction side snubber portion (30b) extending from a suction side (4) of the respective airfoil (16),
wherein the pressure side snubber portion (30a) and the suction side snubber portion (30b) of the snubbers (30) in the second set (L) are oriented differently than the pressure side snubber portion (30a) and the suction side snubber portion (30b) of the snubbers (30) in the first set (H), such that snubbers (30) of adjacent blades (14) of the row of blades meet at a constant radial height (rᵣ).

5. The bladed rotor system (10) according to claim 4, wherein
the pressure side snubber portion (30a) and the suction side snubber portion (30b) of each snubber (30) in the first set (H) extends radially inwardly from said point of attachment (34), and
the pressure side snubber portion (30a) and the suction side snubber portion (30b) of each snubber (30) in the second set (L) extends radially outwardly from said point of attachment (34).

6. The bladed rotor system (10) according to claim 5, wherein the pressure side snubber portion (30a) and the suction side snubber portion (30b) of each snubber (30) in each of the first (H) and second (L) sets extends radially inwardly or outwardly from said point of attachment (34) along a linear profile.

7. The bladed rotor system (10) according to claim 5, wherein
the pressure side snubber portion (30a) and the suction side snubber portion (30b) of each snubber (30) in the first set (H) is curved radially inward from said point of attachment (34), and
the pressure side snubber portion (30a) and the suction side snubber portion (30b) of each snubber (30) in the second set (L) is curved radially outward from said point of attachment (34).

8. The bladed rotor system (10) according to claim 1, wherein the snubbers (30) in the first set (H) and the second set (L) have the same mean radial thickness.

9. A blade (14) for a row of blades in a turbomachine, the blade (14) comprising:
an airfoil (16) extending span-wise along a radial direction from a root portion (18) to an airfoil tip (20); and
a circumferentially extending snubber (30) attached to the airfoil (16) at a mid-span region of the airfoil,
wherein the blade (14) is designed to be identical to a first set (H) of blades (14) or a second set (L) of blades (14) in the row,
wherein the blades (14) of the second set (L) are distinguished from the blades (14) of the first set (H) by a geometry of the snubber (30) that is unique to the respective set (H, L), in which:
the snubbers (30) of the second set (L) are attached to the respective airfoils (16) at a different span-wise height than that of the snubbers (30) of the first set (H), whereby the natural frequency of a blade (14) in the second set (L) differs from the natural frequency of a blade (14) in the first set (H) by a predetermined amount,
wherein blades (14) of the first set (H) and the second set (L) are positioned alternately in the row of blades (14), to provide a frequency mistuning to stabilize flutter of the blades (14).

10. The blade (14) according to claim 9, wherein the snubber (30) comprises a pressure side snubber portion (30a) extending from a pressure side (2) of the airfoil (16) and a suction side snubber portion (30b) extending from a suction side (4) of the airfoil (16), and
wherein the pressure side snubber portion (30a) and the suction side snubber portion (30b) of the snubber extend radially outwardly from a point of attachment (34) of the airfoil (16) to the snubber (30).

11. The blade (14) according to claim 10, wherein the pressure side snubber portion (30a) and the suction side snubber portion (30b) of the snubber (30) extend radially outwardly from said point of attachment (34) along a straight profile.

12. The blade (14) according to claim 10, wherein the pressure side snubber portion (30a) and the suction side snubber portion (30b) of the snubber (30) curve outward from said point of attachment (34).

13. The blade (14) according to claim 9, wherein the snubber (30) comprises a pressure side snubber portion (30a) extending from a pressure side (2) of the airfoil (16) and a suction side snubber portion (30b) extending from a suction side (4) of the airfoil (16), and
wherein the pressure side snubber portion (30a) and the suction side snubber portion (30b) of the snubber (30) extend radially inwardly from a point of attachment (34) of the airfoil (16) to the snubber (30).

14. The blade (14) according to claim 13, wherein the pressure side snubber portion (30a) and the suction side snubber portion (30b) of the snubber (30) extend radially inwardly from said point of attachment (34) along a straight profile.

15. The blade (14) according to claim 13, wherein the pressure side snubber portion (30a) and the suction side snubber portion (30b) of the snubber (30) curve inward from said point of attachment (34).
